(19) United States
(12) Patent Application Publication
(10) Pub. No.: US 2016/0099115 A1
(43) Pub. Date: Apr. 7, 2016

(54) ELECTROLYTES FOR HIGH TEMPERATURE EDLC

(71) Applicant: Corning Incorporated, Corning, NY (US)

(72) Inventors: Shrisudersan Jayaraman, Painted Post, NY (US); Rahul Suryakant Kadam, Corning, NY (US); Steven Isaac Massey, Big Flats, NY (US); Shivani Rao Polasani, Corning, NY (US)

(21) Appl. No.: 14/508,561

(22) Filed: Oct. 7, 2014

(51) Int. Cl. H01G 11/62

(52) U.S. Cl. CPC H01G 11/62

(57) ABSTRACT

An electrolyte composition, including:
an electrolyte comprising a conductive salt; and
a mixture comprising an alkyl nitrile and an alkyl dinitrile, wherein the electrolyte composition has a depressed vapor pressure at 85° C., as defined herein. Also disclosed is an article incorporating the electrolyte composition and methods for making and using the article at elevated temperatures.

The entire disclosure of and publication or patent document mentioned herein is incorporated by reference.

### BACKGROUND

The disclosure relates generally to an electrolyte composition suitable for use in an electrochemical double layer capacitor (EDLC) and like articles operating at elevated temperatures.

### SUMMARY

In embodiments, the disclosure provides an electrolyte composition suitable for use in an EDLC device and like articles operating at elevated temperatures, for example, at about 80 to 90° C., such as 85° C.

In embodiments, the disclosure provides an electrolyte composition comprising: an electrolyte comprising a conductive salt; and a mixture comprising an alkyl nitrile and an alkyl dinitrile suitable for operating the EDLC device and like articles at elevated temperatures as defined herein.

In embodiments, the disclosure provides an EDLC article and like articles including the disclosed electrolyte composition.

In embodiments, the disclosure provides a method of using the disclosed EDLC article containing the disclosed electrolyte composition in, for example, stationary or portable power application.

### BRIEF DESCRIPTION OF DRAWINGS

In embodiments of the disclosure:

FIG. 1 shows a schematic of a PRIOR ART coin cell assembly.

FIG. 2 shows a schematic of a coin cell testing process.

FIG. 3 is a schematic cross-section of a portion of an example PRIOR ART electro-chemical double layer capacitor.

### DETAILED DESCRIPTION

Various embodiments of the disclosure will be described in detail with reference to drawings, if any. Reference to various embodiments does not limit the scope of the invention, which is limited only by the scope of the claims attached hereto. Additionally, any examples set forth in this specification are not limiting and merely set forth some of the many possible embodiments of the claimed invention.

### DEFINITIONS

“EDLC” “electrochemical double layer capacitor,” “supercapacitor,” “ultracapacitor,” and like terms, or like expressions refer an electrochemical capacitor having double layer capacitance and pseudocapacitance. “EDLC cell,” “EDLC button cell,” and like terms refer to an electrochemical double layer capacitor having, for example, a housing, and within or integral with the housing: two electrodes; a separator between the electrodes; an electrolyte in contact with the electrodes; and optionally two current collectors. An electric double layer capacitor, also known as an ultracapacitor, is a device having high power densities and relatively high energy densities compared to conventional electrolytic capacitors. U.S. Pat. Nos. 8,760,851, and 8,842,417, mention and show the structure of a representative EDLC. EDLC's utilize high surface area electrode materials and thin dielectric double layer to achieve capacitance that is several orders of magnitude higher than conventional capacitors. This allows them to be used for energy storage rather than general purpose circuit components. Typical applications include, for example, micro-hybrid and mild hybrid automobiles. A typical EDLC device or article consists of positive and negative electrodes laminated onto aluminum current collector foil. The two electrodes are separated by a porous separator paper in between and wound to make a jelly roll-like structure, which is then packaged in an enclosure containing the organic electrolyte. The porous paper between the positive and negative electrodes allows flow of ionic charge, but at same time prevents transfer of electrons between the two electrodes. With potential applications in, for example, the automotive sector, there is a motivation towards higher energy density, higher power density, and lower cost. These requirements create a need for increased capacitance, widening of the electrolyte operating window, and decreasing the equivalent series resistance (ESR). Significant characteristics of these devices include the energy density and power density, which are determined by the properties of the carbon that is incorporated into the electrodes and electronic resistance at the current collector/electrode interface.

“Alkyl nitrile” or like terms refers to, for example, an monovalent alkyl or a monovalent hydrocarbyl substituent attached to a single nitrile (—C≡N) substituent. The number of carbon atoms in the alkyl nitrile compound includes the carbon of the nitrile substituent. The alkyl or a hydrocarbyl substituent can have a straight carbon chain, or a branched carbon chain.

“Alkyl dinitrile” or like terms refers to, for example, an divalent alkyl or a divalent hydrocarbyl substituent attached to two nitrile (—C≡N) substituent. The number of carbon atoms in the alkyl dinitrile compound includes the carbon of the nitrile substituent. The divalent alkyl or a divalent hydrocarbyl substituent can have, for example, a straight carbon chain, or a branched carbon chain.

“About” modifying, for example, the quantity of an ingredient in a composition, concentrations, volumes, process temperature, process time, yields, flow rates, pressures, viscosities, and like values, and ranges thereof, or a dimension of a component, and like values, and ranges thereof, employed in describing the embodiments of the disclosure, refers to variation in the numerical quantity that can occur, for example: through typical measuring and handling procedures used for preparing materials, compositions, composites, concentrates, component parts, articles of manufacture, or use formulations; through inadvertent error in these procedures; through differences in the manufacture, source, or purity of starting materials or ingredients used to carry out the methods; and like considerations. The term “about” also encompasses amounts that differ due to aging of a composition or formulation with a particular initial concentration or mixture, and amounts that differ due to mixing or processing a composition or formulation with a particular initial concentration or mixture.

“Optional” or “optionally” means that the subsequently described event or circumstance can or cannot occur, and that the description includes instances where the event or circumstance occurs and instances where it does not.

The indefinite article “a” or “an” and its corresponding definite article “the” as used herein means at least one, or one or more, unless specified otherwise.

Abbreviations, which are well known to one of ordinary skill in the art, may be used (e.g., “h” or “hrs” for hour or hours, “g” or “gm” for gram(s), “mL” for milliliters, and “rt” for room temperature, “nm” for nanometers, and like abbreviations).

Specific and preferred values disclosed for components, ingredients, additives, dimensions, conditions, times, and like aspects, and ranges thereof, are for illustration only; they do not exclude other defined values or other values within defined ranges. The composition and methods of the disclosure can include any value or any combination of the values, specific values, more specific values, and preferred values described herein, including explicit or implicit intermediate values and ranges.

Electrochemical double layer capacitors (EDLCs) or Ultracapacitors are energy storage devices having moderate energy densities and high power densities. They are particularly interesting in applications requiring high power (charging as well as discharging) and time constant around 1 to 2 seconds. The long life-time of ultracapacitors (about 15 yrs compared to less than 5 yrs for lead-acid batteries) is a major reason that ultracapacitors have been considered in hybrid automotive vehicles in peak power applications (e.g., regenerative breaking, stop-start).

State-of-the art EDLCs work satisfactorily at temperatures of up to 65° C. However, increasing the operating temperature of the EDLCs expands the markets to these devices in new applications, such as automobiles where the EDLC pack can be placed closer to the engine.

There have been attempts to improve the temperature performance of EDLC through the manipulation of electrolytes (see for example, U.S. Pat. No. 5,418,682, and European Pat App EP0694935A1). However, none of these approaches have been adopted due to lack of satisfactory performance or cost.

U.S. Pat. No. 5,418,682, entitled “Capacitor having an electrolyte containing a mixture of dinitriles,” mentions an electrical capacitor includes an organic electrolyte to provide high power, high energy density, and broad operating temperature range. The capacitor includes electrodes and an electrolyte system comprising a salt combined with a solvent containing a nitrile. The electrolyte system is selected to be relatively nonreactive and difficult to oxidize or reduce so as to produce a high electric potential range. As examples, the electrolyte may include a solvent selected from the group consisting of acetonitrile, succinonitrile (i.e., a dinitrile having 4 carbon atoms), glutaronitrile (i.e., a dinitrile having 5 carbon atoms), propylene carbonate, and ethylene carbonate; a salt cation selected from the group consisting of tetraalkylamonium and alkali metals; and an anion selected from the group consisting of trifluoromethylsulfonate, bistrifluoromethylsulfurylimide, tristrifluoromethylsulfurylcarbanion, tetrafluoroborate, hexafluorophosphate, hexafluoroarsenate, and perchlorate.

U.S. Pat. No. 8,760,851, entitled “Electrochemical Double Layer Capacitor for High Temperature Applications” mentions an EDLC that can operate at high temperatures and can have acetonitrile a solvent choice.

Abu-Lebdeh, Y., et al., mention the use of adiponitrile as a solvent or co-solvent to improve the voltage capability of lithium ion batteries (see “High-Voltage Electrolytes Based on Adiponitrile for Li-Ion Batteries”, Journal of the Electrochemical Society, 156(1) A60-A65 (2009)).

Ducan, et al., mention the use of dinitrile solvents to improve the voltage capability in lithium ion batteries (see “Electrolyte Formulations based on Dinitrile Solvents for High Voltage Li-ion Batteries”, Journal of the Electrochemical Society, 160(6) A838-A848 (2013)).

Gmitter, et al., mention the use of electrolytes consisting predominantly of ethyl methyl carbonate (EMC), which is a linear organic carbonate solvent, 3-methoxypropionitrile (3MPN), which is an alkoxypropionitrile solvent, or adiponitrile (ADN), which is a dinitrile solvent, which solvents were successfully implemented in a 4 V Li-ion system with merely 5 vol % of solid electrolyte interphase (SEI) additive (see “High Concentration Dinitrile, 3-Alkoxypropionitrile, and Linear Carbonate Electrolytes Enabled by Vinylene and Monofluoroethylene Carbonate Additives”, Journal of the Electrochemical Society, 159 (4) A370-A379 (2012).)

In embodiments, the disclosure provides an electrolyte composition suitable for use in an EDLC operating at elevated temperatures, for example, at about 80 to 90° C., such as 85° C.

In embodiments, the disclosure provides a class of electrolyte compositions that enable the ultracapacitor device to operate at higher temperatures, for example, 85° C. compared to the current state-of-the-art of 65° C. The disclosed electrolyte compositions are based on a solvent system including acetonitrile as the primary solvent. By selectively adding one or more co-solvents, the stability window of the device was shifted to higher temperatures. Adding a di-nitrile solvents (i.e., hydrocarbons having a C≡N group on each end of the molecule), having a higher boiling point, a lower vapor pressure, and a dielectric constant of, for example, from 20 to 55, to the acetonitrile primary solvent (dielectric constant of 37.5) increases the stability of the electrolytes, and increases the thermal stability of the article at elevated temperatures, such as 80 to 90° C., and at elevated operating voltages, such as from 2.7 to 3.5 V, from 2.8 to 3.2 V, from 2.9 to 3.1 V, including intermediate values and ranges.

In embodiments, the disclosure provides an electrolyte composition, comprising:

an electrolyte comprising a conductive salt; and

a mixture comprising an alkyl nitrile and an alkyl dinitrile,

wherein the electrolyte composition has a vapor pressure of, for example, from 100 to 600 mm Hg at 85° C., from 480 to about 600 mm Hg at 85° C., and like vapor pressure ranges, which vapor pressure range includes, for example, mixed solvent boiling points of about 95° C.

In embodiments, specific examples of conductive electrolyte salts include, for example, tetraethyl ammonium tetrafluoroborate (Et₄NBF₄), tetraethyl ammonium hexafluorophosphate (Et₄NPF₆), triethylmethylammonium tetrafluoroborate (Et₃MeNBF₄), 1-ethyl-3-methylimidazolium hexafluorophosphate (EMIPF₆), 1-ethyl-3-methylimidazolium-bis(trifluoromethylsulfonyl)imide (EMIIm), methyltripropylammonium hexafluorophosphate (Pr₃MeN⁺PF₆⁻), ethyldimethylsulfonium hexafluorophosphate (EtMe₂S⁻PF₆⁻), triethylmethylammonium bis(trifluoromethane sulfonyl)imide (Et₃MeN⁺Im⁻), triethylmethylphosphonium hexafluorophosphate (Et₃MeP⁺PF₆⁻), spiro-(1,1′)-bipyrrolidinium tetrafluoroborate, and like salts and other known salts used in electrolyte applications, or combinations thereof. The electrolyte may comprise one or more conductive salts.

In embodiments, the alkyl nitrile has from 2 to 5 carbon atoms, and the alkyl dinitrile can have, for example, from 3 to 10 carbon atoms.

In embodiments, the conductive salt can be, for example, a quaternary ammonium salt, the alkyl nitrile can be, for example, acetonitrile, and the alkyl dinitrile can be selected, for example, from adiponitrile, 2-methylglutaronitrile, malononitrile, succinonitrile, glutaronitrile, pimelonitrile, suberonitrile, azelanitrile, sebaconitrile, or a mixture thereof.

In embodiments, the alkyl nitrile can be, for example, acetonitrile, and the alkyl dinitrile can be, for example, adiponitrile, 2-methylglutaronitrile, or a mixture of adiponitrile and 2-methylglutaronitrile.

In embodiments, the alkyl nitrile and alkyl dinitrile mixture can comprise, for example, from 50 to 95 mol % of the alkyl nitrile and from 50 to 5 mole % of the alkyl dinitrile based on 100 mol % of the alkyl nitrile and alkyl dinitrile mixture.

In embodiments, the alkyl nitrile and alkyl dinitrile mixture can comprise, for example, from 60 to 85 mol % of the alkyl nitrile and from 15 to 40 mol % of the alkyl dinitrile based on 100 mol % of the mixture.

In embodiments, the alkyl nitrile and alkyl dinitrile mixture can comprise, for example, from 60 to 85 mol % of the alkyl nitrile as acetonitrile and from 15 to 40 mol % of the alkyl dinitrile as adiponitrile based on a total of 100 mol % of the mixture.

In embodiments, the alkyl nitrile and alkyl dinitrile mixture can comprise, for example, from 60 to 85 mol % of the alkyl nitrile as acetonitrile, and from 15 to 40 mol % of the alkyl dinitrile as 2-methylglutaronitrile based on a total of 100 mol % of the mixture.

In embodiments, the alkyl nitrile can have, for example, a boiling point of from about 80 to 140° C., the alkyl dinitrile can have, for example, a boiling point of from 170 to 325° C., and the alkyl nitrile and alkyl dinitrile mixture can have, for example, a boiling point or is an azeotrope of from 85 to 130° C.

In embodiments, the electrolyte composition can be comprised of a salt and a alkyl nitrile and alkyl dinitrile mixture that can have a vapor pressure of, for example, from 140 to about 580 mm Hg at 85° C.

In embodiments, the disclosure provides a capacitor article comprising: the above mentioned electrolyte composition, wherein the capacitor article can be electrically and thermally stable at from 80 to 90° C., for example, from 1 day to 1 year.

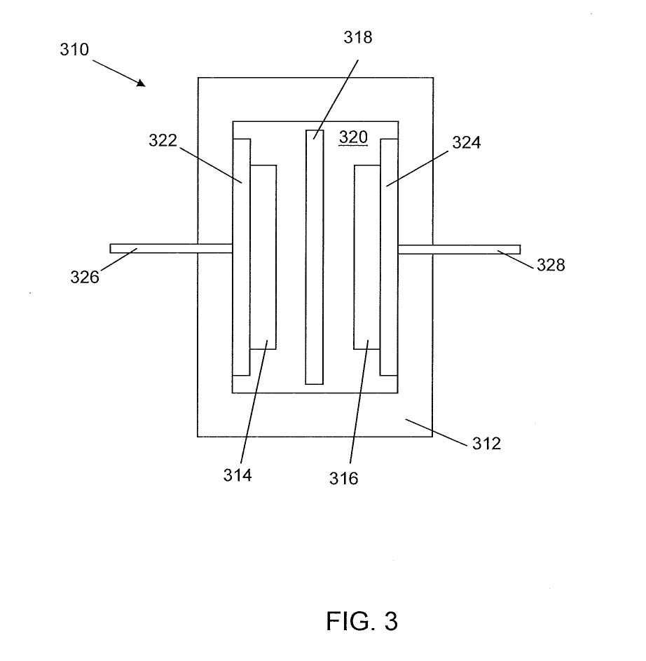

In embodiments, the article can be, for example, an EDLC article, as shown schematically in FIG. 3, comprising:

an enclosing body, housing, or container;

a pair of current collectors;

a positive and a negative electrode comprised of, for example, porous activated carbon layers, each layer formed over one of the current collectors;

one or more porous separator layers made of, for example, paper; and

the disclosed liquid electrolyte composition in the enclosing body and incorporated throughout the porosity of both the porous separator layer and each of the porous electrodes.

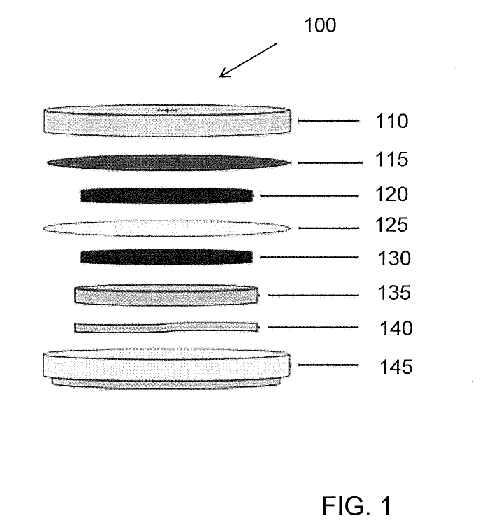

In embodiments, the disclosure provides an article, for example, a coin cell article, as shown in exploded assembly of FIG. 1, comprising:

a first metal casing;

a first metal spacer;

a positive electrode;

a separator;

a negative electrode;

a second metal spacer;

a stainless steel wave spring;

a second metal casing;

an activated carbon layer on at least one electrode; and

filled with the disclosed electrolyte composition.

In embodiments, the disclosure provides a method of using the disclosed EDLC capacitor article, comprising:

accomplishing at least one of:
charging the article at from 80 to 90° C.;
discharging the article at from 80 to 90° C.;
maintaining the article in an idle condition, i.e., an electrically neutral state, with no charging, and with no discharging, at from 80 to 90° C., or a combination thereof

In embodiments, the article, after voltage and temperature stress testing, retains from 70 to 95% of its original capacitance, and has a percent capacitance fade of from 5 to 30%.

In embodiments, the article can have a voltage of from 0 to 3.5 V, from 0 to 3 V, from 0 to 2.7 V, including intermediate values and ranges.

In embodiments, the disclosure provides a method of making an electrolyte composition comprised of a conductive salt and an organic liquid, the method comprising:

combining a mixture of an alkyl nitrile and an alkyl dinitrile as the organic liquid, and a conductive salt such that the electrolyte composition has a vapor pressure of from 480 to about 600 mm Hg at from 80 to 90° C. such as at 85° C.

In embodiments, the organic liquid can be a solid or liquid at ambient temperature, and a liquid at elevated operating temperature, for example, above 60° C., above 65° C., above 70° C., above 75° C., above 80° C., above 85° C., above 90° C., and like temperatures.

In embodiments, the disclosure provides a method of depressing the vapor pressure of an electrolyte composition comprised of a conductive salt and an organic liquid, the method comprising:

selecting the organic liquid comprised of a mixture of an alkyl nitrile and an alkyl dinitrile, and

selecting a conductive salt such that the selected electrolyte composition has a vapor pressure of, for example, from about 130 to about 600 mm Hg at from 80 to 90° C. such as 85° C., from about 200 to about 600 mm Hg at from 80 to 90° C. such as 85° C., and like vapor pressures, including intermediate values and ranges.

In embodiments, the disclosed electrolyte composition, the EDLC article including the disclosed electrolyte composition, and methods thereof are advantaged, for example, as follows.

The disclosed electrolyte composition and articles thereof enable an ultracapacitor device that can operate at, for example, from 80 to 99° C., from 80 to 90° C., such as 85° C. and above, compared to state-of-the-art devices that operate at 65° C.

The disclosed electrolyte co-solvent compositions have a higher boiling point, a higher flash point, and a lower vapor pressure, than a pure acetonitrile electrolyte solvent, which higher points and lower vapor pressure provide a safer electrolyte system in electric articles and devices.

The electrolyte salt can preferably be, for example, selected from known salts, such as tetraethylammonium tetrafluoroborate (TEATFB), triethylmethylammonium tetrafluoroborate (TEMATFB), spiro-(1,1′)-bipyrrolidinium tetrafluoroborate, (SBP-TFB), and like salts, or mixtures thereof.

The electrolyte compositions can be prepared by first mixing a single solvent or a mixture of solvents in a desired molar ratio followed by dissolving the salt in the solvent mixture to a concentration of, for example, 0.5 to 1.5 M, such as 1M. The electrolyte compositions were then dried using molecular sieves until the water content was less than 10 ppm (measured via Karl Fisher titration). The electrolyte compositions consisted of either a single solvent (e.g., acetonitrile; comparative or mixed solvents (e.g., acetonitrile and adiponitrile), and a salt (e.g., tetraethylammonium tetrafluoroborate (TEATFB)).

The electrolyte compositions were tested in coin cells to characterize their high temperature behavior. FIG. 1 shows a schematic of the coin cell assembly (100). The assembly includes an aluminum casing (110), an aluminum spacer (115), a positive electrode (120), a separator (125), a negative electrode (130), a stainless steel spacer (135), a stainless steel wave spring (140), and a stainless steel casing (145). Activated carbon electrodes laminated on an aluminum current collector are used as positive and negative electrodes. The positive and negative electrodes can comprise identical carbon type (i.e., a symmetric configuration) or different carbon types (i.e., a tuned or hybrid configuration). A cellulosic separator (porosity about 50%) was used to electrically isolate the two electrodes. The desired electrolyte can be filled, for example, pipetted in three aliquots of 30 microliters at selected areas of the device. The first aliquot can be added on the positive electrode, the second aliquot can be added on the separator, and the third aliquot can be added around the negative electrode. Alternatively, one or more aliquots can be dispensed robotically such as by injection. The entire assembly is crimped to form a leak-proof cell that can be tested at high temperatures without the loss of the electrolyte composition.

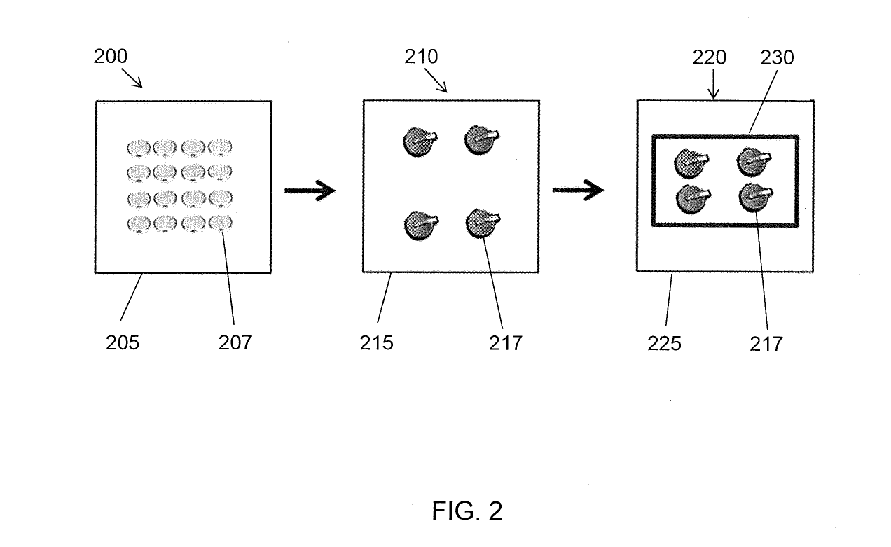

A series of electrochemical tests were performed to characterize the electrolytes. FIG. 2 shows a schematic of the assembly and test process, including cell fabrication (200), test sequence 1 (210), and test sequence 2 (220). Coin cells (207) were assembled inside a glove box (205) to prevent exposure to ambient atmosphere, specifically water. The sealed cells were removed from the box and the electrochemical tests performed. Two sequence of tests were performed. The first test sequence 1 (210) used a Gamry potentiostat or cabinet (215) including the cells (217). The second test sequence 2 (220) used an Arbin electrochemical test system or cabinet (225) including the cells (217) in a crucible (230). The respective test sequences are listed below:

### Test Sequence 1 (Gamry Cabinet)

1. Cyclic voltammetry: 0 to 2.7V, 2 mV/s, 2 cycles

### 2. Electrochemical Impedance Spectroscopy: i) 0V, ii) 2.7V, 100 kHz to 10 mHz

### Test Sequence 2 (Arbin Cabinet)

### 1. Constant Current Cycling 1: Pre-life, Room Temperature

### 2. Constant Current Cycling 2: Pre-life, 85° C.

3. Constant Voltage hold 2.7 V, 85° C., 48 hours

### 4. Constant Current Cycling 3: Post-life, 85° C.

### 5. Constant Current Cycling 4: Post-life, Room Temperature

All constant current cycling was performed at a current magnitude of 5 mA with a 5 minute hold in between charge and discharge steps, and repeated for 3 cycles.

Test sequence 1 was performed to obtain baseline electrochemical behavior of the electrolytes and to condition the cells. Test sequence 2 consisted of stressing the cells at temperature and voltage. Measuring the capacitance of the cells at various stages during this stress test enables one to evaluate the stability of the electrolytes. Step 1 in this test sequence gives the baseline capacitance value at room temperature. Step 2 provides capacitance with just temperature stress (to 85° C.). Step 3 stresses the cells to temperature (85° C.) and voltage (2.7 V). Step 4 measures the capacitance post-stress at temperature (85° C.). Step 5 measures the capacitance post-stress at room temperature. The following notation was used for the tabulated data.

Step 1. RT-Prelife: Room temperature prior to temperature stress

Step 2. HT-Prelife: High temperature prior to voltage and temperature stress

Step 3. HT-Postlife: High temperature after voltage and temperature stress

Step 4. RT-Postlife: Room temperature after voltage and temperature stress

Also, the capacitance fade at a given step is defined as the ratio of the capacitance at a given step to the capacitance from Step 1 (i.e., RT-prelife):

$$\% Capacitance Fade at Step X = \frac{Capacitance from Step X}{Capacitance from Step 1}$$

The Table 1 lists the boiling point of selected di-nitrile solvent compounds. A subset of these di-nitriles were evaluated in the disclosed electrolyte compositions. The boiling point of an alkyl nitrile, acetonitrile of 81.7° C., provides a comparison with the boiling points of the selected di-nitrile compounds.

TABLE 1
Boiling point of selected di-nitrile compounds.

| Solvent | Boiling point (° C.) |
|---|---|
| Adiponitrile | 295 |
| 2-Methylglutaronitrile (2- | 270 |
| MGN) | |
| Malononitrile | 220 |
| Succinonitrile | 266 |
| Glutaronitrile | 287 |
| Pimelonitrile | 175° C. at 14 mmHg |
| Suberonitrile | 185 C. at 15 mmHg |
| Azelanitrile | 209° C. at 33 mmHg |
| Sebaconitrile | 200 |

The boiling point and vapor pressure values, respectively, in Tables 2 and 3 below correspond to the electrolyte composition (i.e., the stated solvent, or solvent mixture, and the electrolyte salt). The salt was tetraethylammonium tetrafluoroborate at a concentration of 1 Molar (salt moles per liter of the solvent or liquid mixture).

TABLE 2
Boiling point of electrolyte compositions having acetonitrile, or a
mixture of acetonitrile (ACN) and adiponitrile (AN).

| | Boiling point (° C.) |
|---|---|
| ACN (control) | 85.0 |
| 90 mole % ACN and 10 mole % AN | 93.9 |
| 80 mole % ACN and 20 mole % AN | 90.6 |

Table 3 provides vapor pressure data derived from the measured boiling point for selected electrolyte compositions.

TABLE 3
Vapor pressure of electrolyte compositions having acetonitrile,
or a mixture of acetonitrile and adiponitrile.

Vapor pressure (mmHg)

| | at 25° C. | at 85° C. |
|---|---|---|
| ACN (control) | 82 | 691 |
| 90 mole % ACN and 10 mole % AN | 55 | 507 |
| 80 mole % ACN and 20 mole % AN | 63 | 568 |

FIG. 3 is a schematic illustration of an example EDLC or ultracapacitor 310, which includes the tailored electrode architecture disclosed herein. Ultracapacitor 310 includes an enclosing body 312, a pair of current collectors 322, 324, a positive electrode 314 and a negative electrode 316 each formed over one of the current collectors, and a porous separator layer 318. Electrical leads 326, 328 can be connected to respective current collectors 322, 324 to provide electrical contact to an external device. Electrodes 314, 316 comprise porous activated carbon layers that are formed over the current collectors. A liquid electrolyte 320 is contained within the enclosing body and incorporated throughout the porosity of both the porous separator layer and each of the porous electrodes. In embodiments, individual ultracapacitor cells can be stacked (e.g., in series) to increase the overall operating voltage. Ultracapacitors can have, e.g., a jelly roll design, prismatic design, honeycomb design, or other suitable configuration.

The enclosing body 312 can be any known enclosure means commonly-used with ultracapacitors. The current collectors 322, 324 generally comprise an electrically-conductive material such as a metal, and commonly are made of aluminum due to its electrical conductivity and relative cost. For example, current collectors 322, 324 may be thin sheets of aluminum foil.

Porous separator 318 electronically insulates the carbon-based electrodes 314, 316 from each other while allowing ion diffusion. The porous separator can be made of a dielectric material such as cellulosic materials, glass, and inorganic or organic polymers such as polypropylene, polyesters or polyolefins. In embodiments, a thickness of the separator layer can range from about 10 to 250 microns.

The electrolyte 320 serves as a promoter of ion conductivity, as a source of ions, and may serve as a binder for the carbon. The electrolyte typically comprises a salt dissolved in a suitable solvent.

### EXAMPLES

The following examples demonstrate the disclosed electrolyte compositions and their effectiveness in EDLC articles operating at elevated temperatures.

### Example 1

### Comparative

Electrodes made of commercial steam carbon (e.g., YP50F available from Kuraray Carbon) were used as the positive and negative electrodes in a coin cell. The electrolyte in this example was 1M TEATFB in superaddition to 100 mol % acetonitrile solvent. The cell failed after the voltage (at 2.7 V) and temperature (at 85° C.) stress evaluation.

| | Capacitance (F) | % Capacitance Fade |
|---|---|---|
| RT-Prelife | 0.61 | 100 |
| HT-Prelife | 0.57 | 93 |
| HT-Postlife | 0.00 | 0 |
| RT-Postlife | 0.00 | 0 |

### Example 2

### Comparative

Electrodes made of commercial steam carbon (e.g., YP50F) were used as the positive and negative electrodes in the coin cell. The electrolyte in this example was 1M TEATFB in superaddition to 90 mol % acetonitrile and 10 mol % adiponitrile solvent mixture. The cell failed after the voltage and temperature stress.

| | Capacitance (F) | % Capacitance Fade |
|---|---|---|
| RT-Prelife | 0.61 | 100 |
| HT-Prelife | 0.59 | 97 |
| HT-Postlife | 0.00 | 0 |
| RT-Postlife | 0.00 | 0 |

### Example 3

### Inventive

Electrodes made of commercial steam carbon (e.g., YP50F) were used as the positive and negative electrodes in the coin cell. The electrolyte in this example was 1M TEATFB in superaddition to 80 mol % acetonitrile and 20 mol % adiponitrile solvent mixture. The cell retained capacitance of greater than 75% until the voltage and temperature stress tests were completed (Step 5).

| | Capacitance (F) | % Capacitance Fade |
|---|---|---|
| RT-Prelife | 0.62 | 100 |
| HT-Prelife | 0.60 | 96 |
| HT-Postlife | 0.50 | 80 |
| RT-Postlife | 0.48 | 78 |

### Example 4

### Inventive

Electrodes made of commercial steam carbon (e.g., YP50F) were used as the positive and negative electrodes in the coin cell. The electrolyte in this example was 1M TEATFB in superaddition to 70 mol % acetonitrile and 30 mol % adiponitrile solvent mixture. The cell retained capacitance of greater than 75% until the voltage and temperature stress tests were completed (Step 5).

| | Capacitance (F) | % Capacitance Fade |
|---|---|---|
| RT-Prelife | 0.63 | 100 |
| HT-Prelife | 0.61 | 97 |
| HT-Postlife | 0.48 | 76 |
| RT-Postlife | 0.47 | 75 |

### Example 5

### Inventive

Electrodes made of commercial steam carbon (e.g., YP50F) were used as both positive and negative electrodes in the coin cell. The electrolyte used in this example is 1M TEATFB in superaddition to 60 mol % acetonitrile and 40 mol % adiponitrile solvent mixture. The cell retained capacitance of greater than 75% until voltage and temperature stress tests were completed (Step 5).

| | Capacitance (F) | % Capacitance Fade |
|---|---|---|
| RT-Prelife | 0.62 | 100 |
| HT-Prelife | 0.60 | 97 |
| HT-Postlife | 0.52 | 84 |
| RT-Postlife | 0.51 | 82 |

### Example 6

### Comparative

Electrodes made of commercial steam carbon (e.g., YP50F) were used as both positive and negative electrodes in the coin cell. The electrolyte used in this example is 1M TEATFB in superaddition to 90 mol % acetonitrile and 10 mol % 2-methylglutaronitrile solvent mixture. The cell failed during voltage and temperature stress tests.

| | Capacitance (F) | % Capacitance Fade |
|---|---|---|
| RT-Prelife | 0.63 | 100 |
| HT-Prelife | 0.61 | 97 |
| HT-Postlife | 0.04 | 6 |
| RT-Postlife | 0.02 | 3 |

### Example 7

### Inventive

Electrodes made of commercial steam carbon (e.g., YP50F) were used as both positive and negative electrodes in the coin cell. The electrolyte used in this example is 1M TEATFB in superaddition to 85 mol % acetonitrile and 15 mol % 2-methylglutaronitrile solvent mixture. The cell retained capacitance of greater than 75% until voltage and temperature stress tests were completed (Step 5).

| | Capacitance (F) | % Capacitance Fade |
|---|---|---|
| RT-Prelife | 0.61 | 100 |
| HT-Prelife | 0.61 | 100 |
| HT-Postlife | 0.47 | 77 |
| RT-Postlife | 0.47 | 77 |

### Example 8

### Inventive

Electrodes made of commercial steam carbon (e.g., YP50F) were used as both positive and negative electrodes in the coin cell. The electrolyte used in this example is 1M TEATFB in superaddition to 80 mol % acetonitrile and 20 mol % 2-methylglutaronitrile solvent mixture. The cell retained capacitance of greater than 75% until voltage and temperature stress tests were completed (Step 5).

| | Capacitance (F) | % Capacitance Fade |
|---|---|---|
| RT-Prelife | 0.61 | 100 |
| HT-Prelife | 0.59 | 97 |
| HT-Postlife | 0.49 | 80 |
| RT-Postlife | 0.51 | 84 |

### Example 9

### Inventive

Electrodes made of commercial steam carbon (e.g., YP50F) were used as both positive and negative electrodes in the coin cell. The electrolyte used in this example is 1M TEATFB in superaddition to 75 mol % acetonitrile and 25 mol % 2-methylglutaronitrile solvent mixture. The cell retained capacitance of greater than 75% until voltage and temperature stress tests were completed (Step 5).

| | Capacitance (F) | % Capacitance Fade |
|---|---|---|
| RT-Prelife | 0.64 | 100 |
| HT-Prelife | 0.62 | 97 |
| HT-Postlife | 0.54 | 84 |
| RT-Postlife | 0.53 | 83 |

### Example 10

### Inventive

Electrodes made of Corning alkali activated carbon (750° C. heat treatment) as described below were used as both positive and negative electrodes in the coin cell. The electrolyte used in this example is 1M TEATFB in superaddition to 80 mol % acetonitrile and 20 mol % adiponitrile solvent mixture. The cell retained capacitance of greater than 70% until voltage and temperature stress tests were completed (Step 5).

| | Capacitance (F) | % Capacitance Fade |
|---|---|---|
| RT-Prelife | 0.71 | 100 |
| HT-Prelife | 0.64 | 90 |
| HT-Postlife | 0.51 | 72 |
| RT-Postlife | 0.51 | 72 |

The Corning carbon was made from a wheat flour precursor. The wheat flour was carbonized at from 650 to 700° C. The carbonized carbon was ground to a particle size of approximately 5 microns. The ground carbonized carbon was then activated at 750° C. with KOH (alkali) in a weight ratio of 2.2:1 KOH:carbon for 2 hours. The carbon was further washed with water to remove any remaining KOH. The resulting activated carbon was then treated with HCL to neutralize any trace of KOH and then washed with water to neutralize the carbon to a pH of 7. The activated carbon was then heat-treated under nitrogen and hydrogen forming gas at 900° C. for 2 hrs. The electrode consisted of 85% in-house made wheat flour based alkali activated carbon, 10 wt % PTFE (Du Pont 601A Teflon PTFE), and 5 wt % Cabot Black Pearl 2000, and was used as both positive and negative electrodes in the coin cell (see for example, U.S. Pat. Nos. 8,318,356, 8,524,632, 8,541,338, and 8,784,764).

### Example 11

### Inventive

Electrodes made of Corning alkali activated carbon (900° C. heat treatment), as described above, were used as both positive and negative electrodes in the coin cell. The electrolyte used in this example is 1M TEATFB in superaddition to 80 mol % acetonitrile and 20 mol % adiponitrile solvent mixture. The cell retained capacitance of greater than 70% until voltage and temperature stress tests were completed (Step 5).

| | Capacitance (F) | % Capacitance Fade |
|---|---|---|
| RT-Prelife | 0.66 | 100 |
| HT-Prelife | 0.59 | 89 |
| HT-Postlife | 0.49 | 74 |
| RT-Postlife | 0.49 | 74 |

The foregoing examples demonstrate the temperature advantage of the evaluated electrolyte compositions. Based on the nature of their functional group, it is evident that solvents containing two or more nitrile groups (e.g., dinitriles) provide stability to the acetonitrile based electrolyte formulations.

The disclosure has been described with reference to various specific embodiments and techniques. However, many variations and modifications are possible while remaining within the scope of the disclosure.

What is claimed:

1. An electrolyte composition, comprising:
an electrolyte comprising a conductive salt; and
a mixture comprising an alkyl nitrile and an alkyl dinitrile,
wherein the electrolyte composition has a vapor pressure of from 480 to about 600 mm Hg at 85° C.

2. The composition of claim 1, wherein the conductive salt is a tetraethyl ammonium tetrafluoroborate (Et₄NBF₄), tetraethyl ammonium hexafluorophosphate (Et₄NPF₆), triethylmethylammonium tetrafluoroborate (Et₃MeNBF₄), 1-ethyl-3-methylimidazolium hexafluorophosphate (EMIPF₆), 1-ethyl-3-methylimidazolium-bis(trifluoromethylsulfonyl)imide (EMIIm), methyltripropylammonium hexafluorophosphate (Pr₃MeN⁺PF₆⁻), ethyldimethylsulfonium hexafluorophosphate (EtMe₂S⁺PF₆⁻), triethylmethylammonium bis(trifluoromethane sulfonyl)imide (Et₃MeN⁺Im⁻), triethylmethylphosphonium hexafluorophosphate (Et₃MeP⁺PF₆⁻), spiro-(1,1′)-bipyrrolidinium tetrafluoroborate, or a combination thereof, and the alkyl nitrile has from 2 to 5 carbon atoms, and the alkyl dinitrile has from 3 to 10 carbon atoms.

3. The composition of claim 1, wherein the conductive salt is a quaternary ammonium salt, the alkyl nitrile is acetonitrile, and the alkyl dinitrile is selected from adiponitrile, 2-methylglutaronitrile, malononitrile, succinonitrile, glutaronitrile, pimelonitrile, suberonitrile, azelanitrile, sebaconitrile, or a mixture thereof.

4. The composition of claim 1, wherein the alkyl nitrile is acetonitrile, and the alkyl dinitrile is adiponitrile, 2-methylglutaronitrile, or a mixture of adiponitrile and 2-methylglutaronitrile.

5. The composition of claim 1, wherein the mixture comprises from 50 to 95 mol % of the alkyl nitrile and from 50 to 5 mole % of the alkyl dinitrile based on 100 mol % of the solvent mixture.

6. The composition of claim 1, wherein the mixture comprises from 60 to 85 mol % of the alkyl nitrile and from 15 to 40 mol % of the alkyl dinitrile.

7. The composition of claim 1, wherein the mixture comprises from 60 to 85 mol % of the alkyl nitrile as acetonitrile and from 15 to 40 mol % of the alkyl dinitrile as adiponitrile.

8. The composition of claim 1, wherein the mixture comprises from 60 to 85 mol % of the alkyl nitrile as acetonitrile, and from 15 to 40 mol % of the alkyl dinitrile as 2-methylglutaronitrile.

9. The composition of claim 1, wherein the alkyl nitrile has a boiling point of from 80 to 140° C., the alkyl dinitrile has a boiling point of from 170 to 325° C., and the mixture has a boiling point or is an azeotrope of from 85 to 130° C.

10. A capacitor article comprising: the electrolyte composition of claim 1, wherein the capacitor article is electrically and thermally stable at from 80 to 90° C. for from 1 day to 1 year.

11. A method of using the capacitor article of claim 10 comprising:
accomplishing at least one of:
charging the article at from 80 to 90° C.;
discharging the article at from 80 to 90° C.;
maintaining the article in an idle condition at from 80 to 90° C., or a combination thereof.

12. The method of claim 11 wherein the article, after voltage and temperature stress testing, retains from 70 to 95% of its original capacitance, and has a percent capacitance fade of from 5 to 30%.

13. The method of claim 11 wherein the article has a voltage of from 0 to 3.5 V.

14. The method of claim 11 wherein the article has a voltage of from 0 to 3 V.

15. The method of claim 11 wherein the article has a voltage of from 0 to 2.7 V.

16. A method of making an electrolyte composition comprised of a conductive salt and an organic liquid, the method comprising:
combining a mixture of an alkyl nitrile and an alkyl dinitrile as the organic liquid, and a conductive salt such that the electrolyte composition has a vapor pressure of from 480 to about 600 mm Hg at 85° C.
